(19) United States
(12) Patent Application Publication
(10) Pub. No.: US 2009/0276515 A1
(43) Pub. Date: Nov. 5, 2009

(54) MULTI-MODALITY NETWORK FOR IMPROVED WORKFLOW

(75) Inventors: Lewis Thomas, Palo Alto, CA (US); Maz So, Fremont, CA (US); Jon M. Knight, Pleasanton, CA (US); Rahul Choudhury, Fremont, CA (US); Tat-Jin Teo, Sunnyvale, CA (US)

Correspondence Address: Boston Scientific Corporation;Darby & Darby P.C., P.O. Box 770, Church Street Station, New York, NY, 10008-0770, US

(73) Assignee: Boston Scientific SciMed, Inc., Maple Grove, MN (US)

(21) Appl. No.: 12/427,941

(22) Filed: Apr. 22, 2009

Related U.S. Application Data
(60) Provisional application No. 61/050,132, filed on May 2, 2008.

(51) Int. Cl. G06F 15/16; G06F 3/041

(52) U.S. Cl. 709/223; 709/245; 345/173; 709/227

(57) ABSTRACT

Described herein are systems and methods for multi-modality networks that provide access to different medical devices though a common operator interface. In an example embodiment, a multi-modality network comprises a host computer and a plurality of medical devices. The medical devices may support different diagnostic and/or therapeutic modalities. The host computer communicates with the medical devices through a communications network. In one embodiment, the host computer includes a display and a control console that allow the physician or operator to control the different medical devices and view images and measurements from the different medical devices through a common interface. Further, the host computer may provide computing resources, e.g., a general purpose image processor, that can be shared among the different modalities.

### CROSS REFERENCE TO RELATED APPLICATION

This application claims the benefit of U.S. Provisional Patent Application Ser. No. 61/050,132, filed May 2, 2008, the entire contents of which is incorporated herein by reference.

### FIELD OF THE INVENTION

The present invention relates to medical systems, and more particularly to multi-modality networks for providing access to different medical devices through a common interface.

### BACKGROUND INFORMATION

A laboratory or operating room is a place where several minimally invasive procedures may be routinely performed. Consequently, several medical devices are needed to support the many different interventional and diagnostic procedures that may be performed. Therefore, there is a desire to decrease setup time and improve workflow by performing different procedures through a common interface. At the same time, there is a desire to decrease the time to market and the financial investment in integrating these different procedures by exploiting the common design and development process for a common interface.

### SUMMARY OF THE INVENTION

Described herein are systems and methods for multi-modality networks that provide access to different medical devices though a common interface.

In an example embodiment, a multi-modality network comprises a host computer and a plurality of medical devices. The medical devices may support different diagnostic and/or therapeutic modalities. The host computer communicates with the medical devices through a communications network. In one embodiment, the host computer includes a display and a control console that allow the physician or operator to control the different medical devices and view images and measurements from the different medical devices through a common interface. Further, the host computer may provide computing resources, e.g., a general purpose image processor, that can be shared among the different modalities.

In another example embodiment, the host computer communicates with the medical devices through a standard network interface using standard communications protocols, e.g., Ethernet. This example embodiment simplifies communications between the host computer and medical devices and eliminates the need for device-specific driver cards on the host computer.

In another example embodiment, the host computer is coupled to the medical devices through a network hub. In one embodiment, the network hub electrically isolates the medical devices from one another and/or the host computer, while providing patient safety barrier. The network hub may also provide power to the medical devices and/or a ground connection for the medical devices.

In another example embodiment, the common interface includes one or more touch screen control panels that display a set of controls that the operator can select by touching the touch screen. In one embodiment, each medical device has one or more sets of controls associated with it, which can be displayed on the one or more touch screens when the operator selects the medical device.

In another example embodiment, the host computer comprises a plurality of programs (e.g., software and/or firmware) for interacting with different medical devices over the communications network. In this embodiment, a newly added medical device sends an identifier to the host computer which the host computer uses to recognize the medical device and determine the appropriate program or software path to interact with the device. Alternatively or in addition, a newly added medical device may send a program to the host computer instructing the host computer how to interact with the medical device. The program may specify the layout of controls for the medical device on a touch screen, commands and data structures for the medical device, a workflow for performing a procedure, layout of the graphical data to present to the user on the user display, etc. The host computer may also comprise a set of standard data structures, controls, display layouts, program modules (e.g., for common routines), etc. that can be utilized by the program. The set of standards can be used to simplify the program for a medical device while providing flexibility to customize a presentation for the medical device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

In order to better appreciate how the above-recited and other advantages and objects of the present inventions are obtained, a more particular description of the invention briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 shows an example multi-modality network.

FIG. 2 shows an example touch screen control panel.

FIG. 3A shows an example network hub.

FIG. 3B shows the network hub with network links that provide both data and power transmission.

FIG. 4 shows an example network with a shared transmission line.

FIG. 5A-5C show example networks without a network hub.

FIG. 6 shows an example network using a ring topology.

FIG. 7 shows an example medical device for intravascular imaging.

FIG. 8 shows an example medical device with an imager.

FIG. 9 shows an example medical device with a sensor.

FIG. 10 shows a block diagram of an example host computer.

### DETAILED DESCRIPTION

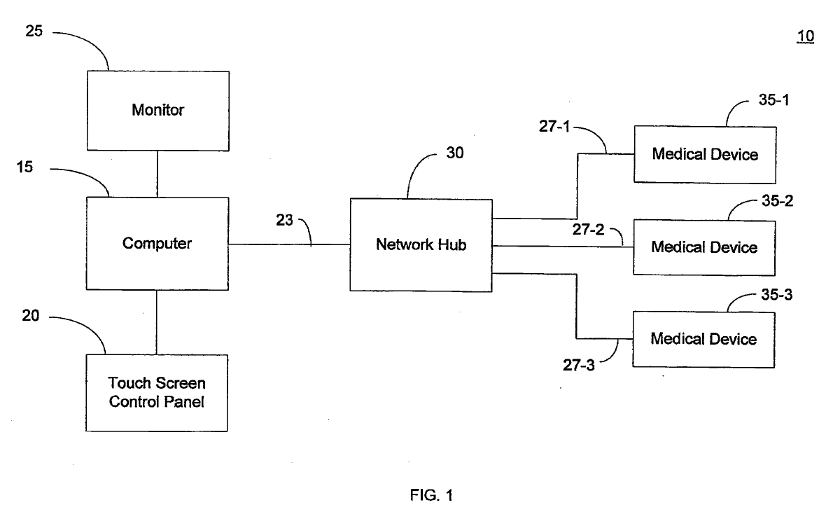

FIG. 1 shows a block diagram of an example multi-modality network 10. The network 10 comprises a host computer 15 and a plurality of medical devices 35-1 to 35-3, each of which may be a diagnostic and/or therapeutic device. For example, a medical device 35-1 to 35-3 may acquire image data from a patient using an imager, perform measurements in the patient, and/or perform therapy (e.g., delivering therapeutic agent to a patient). Although three medical devices 35-1 to 35-3 are shown in the example in FIG. 1, the network 10 may include any number of medical devices. In a preferred embodiment, the network 10 is flexible allowing medical devices 35-1 and 35-3 to be added to or removed from the network 10. The host computer 15 may be installed in a laboratory room or an adjacent control room. The example network 10 also comprises a network hub 30 that couples communications between the host computer 15 to the medical devices 35-1 to 35-3. Other network configurations may be used besides the example shown in FIG. 1 including a ring configuration, a common bus configuration, a tree configuration, daisy-chain configuration, and the like. Examples of other network configurations are given below.

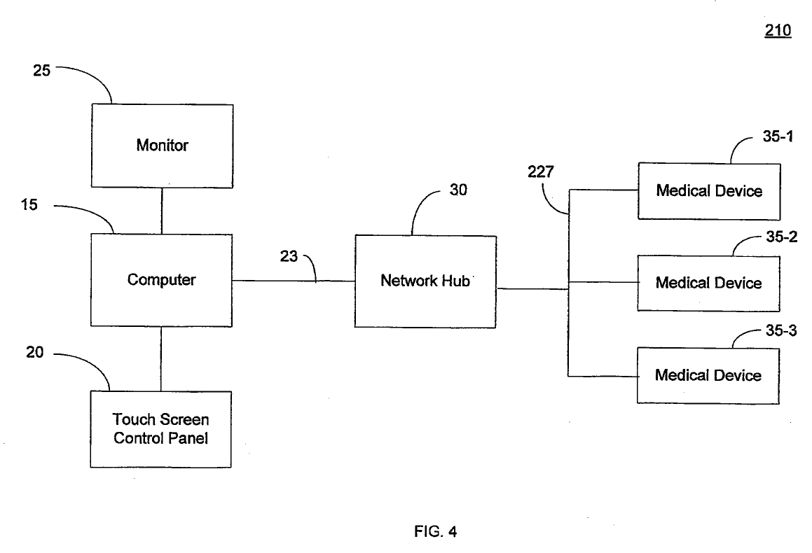

The network hub 30 is coupled to the host computer 15 via communications link 23 and to the medical devices 35-1 to 35-3 via communications links 27-1 to 27-3. In the example shown, the network hub 30 is coupled to each medical device 35-1 to 35-3 by a separate point-to-point link 27-1 to 27-3. Alternatively, the medical devices 35-1 to 35-3 may be coupled to the network hub 30 over a shared transmission line as shown in FIG. 4. In an embodiment, the network hub 30 provides electrical isolation and/or power for the medical devices 35-1 to 35-3, as explained further below. The links 23 and 27-1 to 28-3 may comprise twisted pair wires, coaxial cables, optical fibers, wireless links, and/or a combination thereof. A wireless link requires a wireless transceiver at both ends of the link. The medical devices 35-1 and 35-3 and host computer 15 may communicate with each other over the network 10, e.g., using industry-standard protocols such as Ethernet protocols (e.g., IEEE 802.3). An advantage of using standard Ethernet protocols is that they provide protocols for transporting information, addressing devices coupled to the network (e.g., MAC addresses) and handling access to the network (e.g., Carrier Sense Multiple Access/Collision Detection). Examples of industry standards that may be used for the links include copper-based Ethernet (10/100/1000/1000BaseT) and optical-based Ethernet, Token-Ring, USB (1.1, 2.0), IEEE 1394 (a and b), and other standards. Examples of wireless standards include IEEE 802.11a, 802.11b, 802.11b, 802.11g, 802.11n, Bluetooth, Zigbee, UWB (Ultra Wide Band), and other wireless standards. Examples of standards for transmitting images and video include Digital Video (DV), HD-Digital Video (HD-DV), S-video, NTSC, PAL, DVI, HDMI, and other standards.

The medical devices 35-1 to 35-3 may comprise devices employing different imaging modalities, e.g., intravascular ultrasound, ultrasound array beamformer, optical coherence tomography (OCT), Raman spectroscopy, MRI, and the like. A more detailed discussion of example medical devices is given below. The network 10 advantageously allows a physician to access different medical devices 35-1 to 35-3 on the network using a common interface (e.g., monitor 25 and control panel 20 coupled to the computer 15). For example, the network 10 allows a physician to acquire images from devices using different imaging modalities and view the images on a common interface. Further, using a common interface allows a medical device manufacturer or vender to manufacture a medical device without a control console and/or display, thereby reducing development, manufacturing, and equipment costs. Alternatively, a medical device may have a simplified control console and/or display compared with a standalone medical device with an understanding that the physician will access the device primarily through the common control console and/or will only need to access a subset of the controls at the medical device.

In the preferred embodiment, a monitor (e.g., LCD monitor) and a touch screen control panel 20 are coupled to the computer 15. The monitor 25 is used to display images and/or measurements received from the medical devices 35-1 to 35-3. The touch screen control panel 20 displays controls that allow the physician to interface with the computer 15 and issue commands to the medical devices 35-1 to 35-3 via the computer 15. An advantage of using a touch screen control panel 20 is that it can display different sets of controls corresponding to the different medical devices 35-1 to 35-3. For example, the touch screen control panel 20 may display a set of controls corresponding to medical device 35-1 when the physician selects medical device 35-1. The touch screen control panel 20 may display a set of icons where each icon represents one of the medical devices 35-1 to 35-3 currently coupled to the network. In this embodiment, the physician selects one of the medical devices 35-1 to 35-3 by touching the corresponding icon on the control panel 20. Thus, the physician can choose the medical device according to clinical need. Also, the selected medical device may be automatically activated when the physician selects the device.

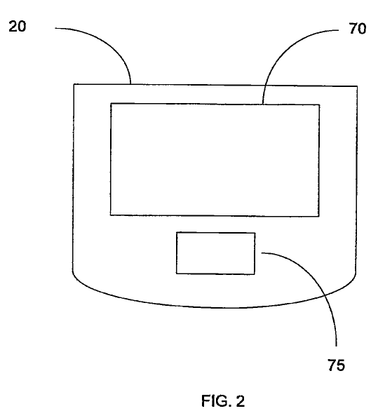

An example touch screen control panel is shown in FIG. 2. The control panel 20 in this example comprises a touch screen 70 that displays controls that the physician selects by touching the screen 70. The control panel 20 also comprises a touch pad 75, which the physician can use to move a pointer on the monitor 25. For example, the physician can use the touch pad 25 to move the pointer to desired sites in an image displayed on the monitor 25 and select the desired sites, e.g., to display measurements corresponding to the selected sites, bookmark the sites, etc. Instead of a touch pad 75, a trackball or a mouse may be used. The control panel 20 may be positioned directly below the monitor 25. Also, more than one control panel 20 may be deployed as dictated by the user's needs and desire to improve the procedural workflow.

The host computer 15 may be a PC-based computer with software and/or firmware for interacting with the medical devices 35-1 to 35-3 over the network 10, processing data from the medical devices 35-1 to 35-3, and/or controlling the control panel 20. The computer 15 may interact with the medical device 35-1 to 35-3 using interaction protocols that run on top of the communications protocols (e.g., standard Ethernet protocols). For the example of Ethernet, the Ethernet protocols would handle data transport and control access to the network, while the interaction protocols would specify, e.g., commands and data structures sent between the host computer 15 and the medical devices 35-1 to 35-3. As an example, the host computer 15 may send a command to one of the medical devices 35-1 to 35-3 to acquire one or more images and in response, the medical device 35-1 to 35-3 acquires the image and sends corresponding image data to the host computer 15. A more detailed discussion of example interaction protocols is given below.

The computer 15 may also comprise a network interface card (e.g., Ethernet card) for interfacing to the network 10, a display driver, a graphics processor, and a storage medium for storing and archiving images and other data from the acquisition devices 35-1 to 35-3. The storage medium may include a hard drive, a removable storage device, DVD, or the like. The computer 15 may be coupled to a Local Area Network (LAN) or the Internet for exporting data to another computer, e.g., in the same hospital for offline diagnosis.

An advantage of the host computer 15 is that it provides shared computing resources for processing data received from the different medical devices 35-1 to 35-3. For example, the host computer 15 may provide a graphics and image processor that can be used for processing image data from different imaging modalities. This may eliminate or simplify the image processor required on a medical device, thereby reducing the cost and/or development time of the medical device.

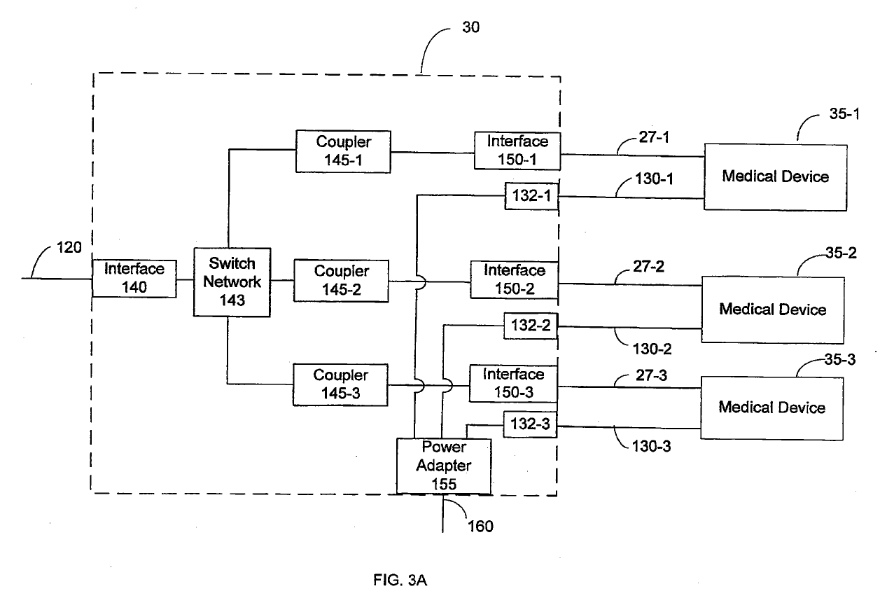

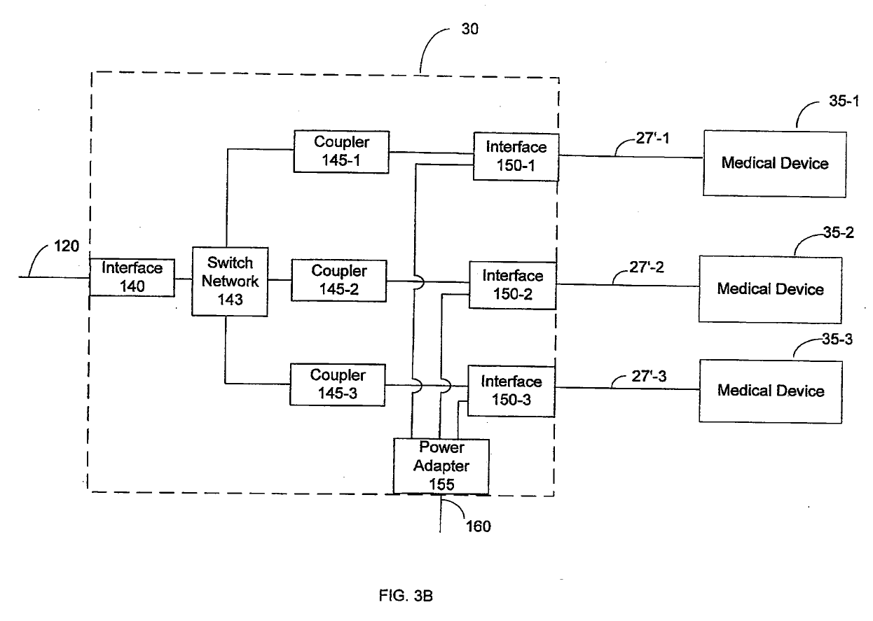

FIG. 3A shows a block diagram of a network hub 30 according to an embodiment of the present invention. In this example, the network hub comprises one or more interfaces 140 for coupling to the host computer 15 and a plurality of interfaces 150-1 to 150-3 for coupling to the medical devices 35-1 to 35-3. Although three interfaces 150-1 to 150-3 to the medical devices are shown in the example in FIG. 3A, the network hub 30 may include any number of interfaces 150-1 to 150-3. Each interface 140 and 150-1 to 150-3 may comprise drive circuitry for driving signals on the corresponding link, receive circuitry for receiving signals from the corresponding link, and a port for connecting to one end of the link (e.g., RJ connector, BNC connector, or the like). The network hub 30 further comprises electrical isolation couplers 145-1 to 145-3 for providing communications between the devices on the network 10 while electrically isolating the devices from one another. The electrical isolation couplers 145-1 to 145-3 prevent an electrical surge from one device from propagating to another device coupled to the network 10. This is especially advantageous when one of the devices includes a component (e.g., a probe or a catheter) contacting and/or inserted into a patient, which could harm the patient if an electrical surge is allowed to propagate to the patient. Thus, the network hub 30 can be used to provide patient isolation for the medical devices 35-1 to 35-3.

The electrical isolation couplers 145-1 to 145-3 may comprise optical couplers, transformers, capacitive couplers, or the like. An optical coupler provides electrical isolation by converting an electrical signal at one end into an optical signal and converting the optical signal back into an electrical signal at the other end. The optical coupler may comprise one or more LEDs in each direction of communication for converting an electrical signal into an optical signal and a photo detector for converting the optical signal back into an electrical signal. An electrical isolation coupler may also comprise an electrical surge detector coupled to a switch that disconnects the corresponding device from the network 10 when an electrical surge is detected by the electrical surge detector.

The network hub 30 may comprise couplers only between devices where there is a danger of an electrical surge instead of a coupler between each pair of devices coupled to the network 30. For example, the network hub 30 may comprise one coupler between the host computer 15 and all of the medical devices 130-1 to 103-3 coupled to the hub.

The network hub 30 may also comprise a switching network 143, e.g., for disconnecting and isolating a faulty device from the network 10 through a switch. The switching network may also be used to route signals from a source device only to a destination device on the network 30. The network hub 30 may also provide power to the medical devices 35-1 to 35-3 through power transmission lines 130-1 to 130-3, each power transmission line 130-1 to 130-3 coupled at one end to one of the medical devices 35-1 to 35-3 and at the other end to a power connector 132-1 to 132-3 of the network hub 30. Each power transmission line 130-1 to 130-3 may include a ground wire to connect to a ground via the network hub 30. The network hub 30 may supply power from a power outlet or other power source (not shown) via power line 160. The network hub 30 may also comprise a power adapter 155 for adapting power from the power source into power suitable for the corresponding medical device 35-1 to 35-3. For example, the power adapter 155 may, e.g., convert AC power from the power source into DC power, change voltage levels, or the like. The power adapter may also include one or more surge protectors (not shown) for protecting the medical devices 35-1 to 35-3 from electrical surges. The power adapter may also include medical grade isolation transformers with double or reinforced insulation to provide patient safety barrier from a single fault condition from a local power source.

Each power transmission line 130-1 to 130-3 may be bundled with the corresponding communications link 27-1 to 27-3 in the same physical cable. For example, some Ethernet cables include additional wires that may be used to transmit power. FIG. 3B shows an embodiment of the network hub 30 in which both data and power are transmitted to a medical device 35-1 to 35-3 via a network link 27′-1 to 27′-3. Each network link 27′-1 to 27-′3 may comprise an Ethernet cable or LAN line that includes separate wires for data transmission and power transmission. In this embodiment, the power adapter is coupled to the network interfaces 150-1 to 150-3. An advantage of this embodiment is that the user only needs to connect one link between the medical device 35-1 to 35-3 and the network hub 30 to provide both data communications and power transmission, thereby easing installation.

Providing power to the medical devices 35-1 to 35-3 from the network hub 30 has the advantage of reducing the size of the medical devices by eliminating the need to provide a battery and/or separate power supply on the medical device 35-1 to 35-3.

FIG. 4 shows another example network 210, in which the medical devices 35-1 to 35-3 are coupled to the network hub over a shared transmission line 227 (e.g., shared cable). In this embodiment, the medical devices 35-1 to 35-3 on the shared transmission line 227 may be addressed, e.g., using MAC addresses for an Ethernet standard. The network hub 30 may include an electrical isolation coupler between the host computer 20 and the shared transmission line 227 to electrical isolate the host computer 15 from the medical devices 35-1 to 35-3.

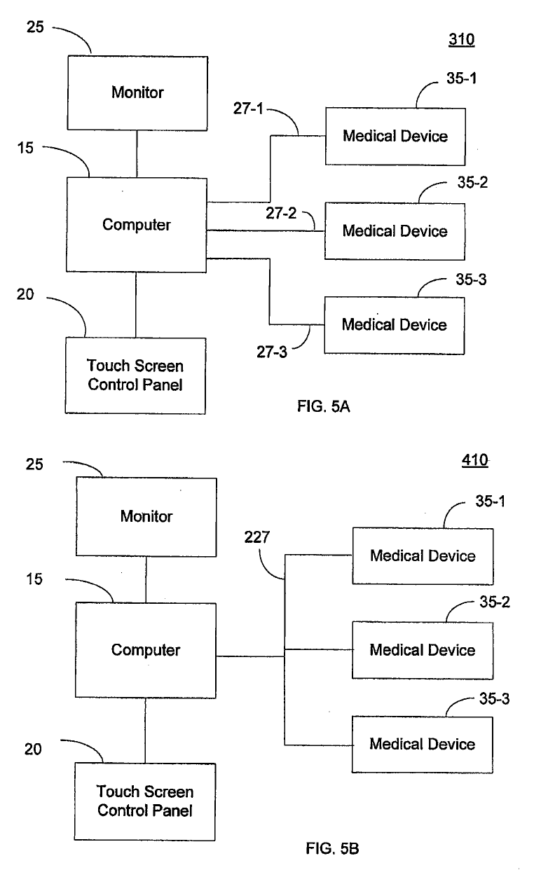

FIG. 5A shows another example network 310, in which the medical devices 35-1 to 35-3 are coupled to the host computer 15 without a network hub via communications links 27-1 to 27-3. The links 27-1 to 27-3 may comprise twisted pair wires, coaxial cables, optical fibers, wireless links (IEEE 802.11), and/or a combination thereof. For the example of Ethernet, the links 27-1 to 27-1 may plug into the ports of one or more Ethernet interface cards in the host computer 15. An advantage of using Ethernet or other industry standard is that a standard Patent interface card can be used to interact with the medical devices instead of requiring a device-specific driver card for each medical device. Further, using Ethernet or other standard allows a link 27-1 to 27-3 to be plugged into anyone of several ports of the computer 15 without having to worry about matching the link to the port of a particular driver card designed for the corresponding medical device, thereby making installation easier.

FIG. 5B shows another example network 410, in which the medical devices 35-1 to 35-3 are coupled to the host computer 15 without a network hub via a shared transmission line 227 (e.g., a shared cable). For the example of Ethernet, the shared transmission line 227 may plug into the port of an Ethernet interface card in the host computer 15. FIG. 5C shows an example network 510, in which two medical devices 35-1 to 35-2 share a bus 227 while medical device 35-3 is coupled to the host computer 15 by a separate line 27. Any number of medical devices may be coupled on a shared transmission line 227 and any number of acquisition devices may be coupled to the computer 15 by separate links 27.

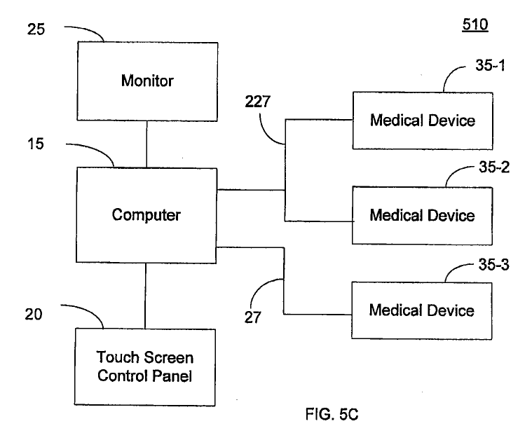

FIG. 6 shows an example of a ring topology, in which the computer 15 and medical devices 35-1 to 35-3 are coupled to a ring 327. In this example, access to the network 610 may be controlled by a token that passes from devices to device on the ring 327 where possession of the token grants a device the right to transmit information on the ring 327. An example Token-Ring standard is IEEE 802.5.

The above examples are intended only to aid in the illustration of the various network configurations that are possible. Since a large number of configurations are possible, it is not intended that the network be limited to the example embodiments described or depicted herein.

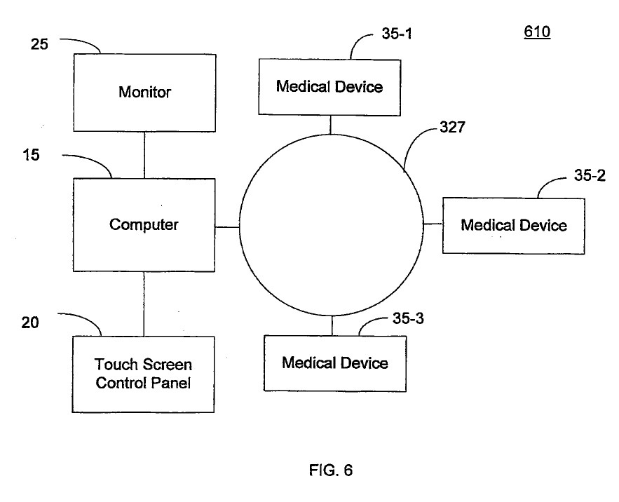

FIG. 7 shows an example medical device that can be coupled to the network. In this example, the medical device is an intravascular ultrasound (IVUS) imaging device 405 for acquiring ultrasound images within a blood vessel (e.g., artery or vein) of a patient. The imaging device 405 comprises an IVUS catheter 425, a motor drive unit (MDU) 415 coupled to the catheter 420, and an acquisition processor 418. The IVUS catheter 425 comprises a flexible catheter sheath 430 adapted to be inserted into a blood vessel and an imaging core 433 that slides within the catheter sheath 430 and has a proximal end coupled to the MDU 415. The imaging core 433 comprises a flexible drive shaft 435 and an ultrasound transducer 440 coupled to the distal end of the drive shaft 435. The transducer 440 acquires a scan line of an image by emitting an ultrasonic wave and receiving the return wave. The IVUS catheter 425 is typically a disposable unit that is discarded after one use. The MDU 415 typically comprises a rotational motor for rotating the imaging core 433 and a linear motor for moving the imaging core 433 longitudinally within the catheter sheath 430, e.g., during a pullback procedure. The acquisition processor 418 controls the MDU 415 and processes the raw data from the MDU 415 into image data to be sent to the host computer 15. The acquisition processor 418 may be PC-based. The device 405 may also include memory 425 for storing software, temporarily storing data being processed, buffering data, and the like. The memory 425 may comprise RA, nonvolatile memory (e.g., Flash memory), buffers, and/or a combination thereof.

To image within a blood vessel, the catheter is advanced to a desired region within the blood vessel. To obtain a two-dimensional cross-sectional image of a blood vessel, the MDU 415 rotates the imaging core 433 allowing the transducer 440 to scan a rotational cross-section of the blood vessel. Typically, the transducer 440 is rotated one revolution to acquire one cross-sectional image. To scan a volume of the blood vessel, the MDU 415 incrementally pulls back the imaging core 433 along the blood vessel allowing the imaging core 433 to obtain a series of cross-sectional images along the blood vessel. These cross-sectional images can be stacked to form a three-dimensional image of the blood vessel. The acquisition processor 418 controls the MDU 415 and imaging core 433 according to the desired imaging procedure. For example, the acquisition processor 418 may control the MDU 415 and imaging core 433 according to a desired pullback length, pullback rate, and image frame rate where each image frame corresponds to one cross-sectional image (typically one revolution of the imaging core).

In this embodiment, the imaging device 405 comprises a network interface 420 for interfacing the acquisition processor 418 to the network via a link 427. In a preferred embodiment, the network interface 420 uses an industry standard, e.g., Ethernet, for sending and receiving information to and from the host computer 15 via the network. In this example, the acquisition processor 418 may receive commands from the host computer 15 using command protocols that run on top of the communications protocols (e.g., Ethernet protocols). The network interface 420 and acquisition processor 418 may be implemented in a PC-based computer or other computer that is coupled to the MDU 415 by a control/data link.

As an example, the host computer 15 may send commands to the acquisition processor via the network to perform an imaging procedure, in which the commands may specify the pullback length, pullback rate, and/or image frame rate of the imaging procedure. In response, the acquisition processor 418 acquires the image frames, and sends the image frame data to the host computer 15. The acquisition processor 418 may send the image data for the frames to the host computer 15 serially (i.e., one frame at a time). The data for each frame may include a number indicating the order of the frame in the series of frames. The acquisition processor 418 may also send status indicators to the host computer 15. The status indicators may indicate when the imaging device has stared and/or finished the imaging procedure, or that the imaging device is not ready. The acquisition processor 418 may also send an error code to the host computer 15 when the MDU is not functioning properly.

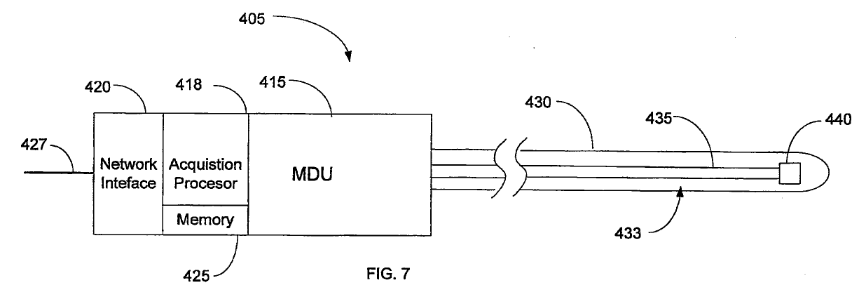

FIG. 8 shows an example of a medical device 505 for an imaging modality. The medical device 505 comprises a network interface 520, an acquisition processor 518, an imaging system 515, and an imager 530. The imager 530 may comprise an ultrasound array, an MRI, OCT imager, etc. The imaging system 515 drives the imager 530 and receives signals from the imager 530. For the example of an OCT imager 530, the imaging system 515 may include a light source for the OCT imager 530, and an optical signal processor (e.g., interferometer) for processing optical signals from the imager 530 into electrical signals containing image information that are inputted to the acquisition processor 518. The acquisition processor 518 controls the imaging system 515 based on commands received from the host computer, and sends image data and other information (e.g., status information) to the host computer. The acquisition processor 518 may be PC-based or other type of processor. The acquisition processor 518 communicates with the host computer over the network via the network interface 520, which may comprise a standard network interface card. The device 505 may also include memory 525 for storing software (e.g., software uploaded to the host computer), temporarily storing data being processed, buffering data, and the like. The memory 525 may comprise RAM, nonvolatile memory (e.g., Flash memory), buffers, and/or a combination thereof.

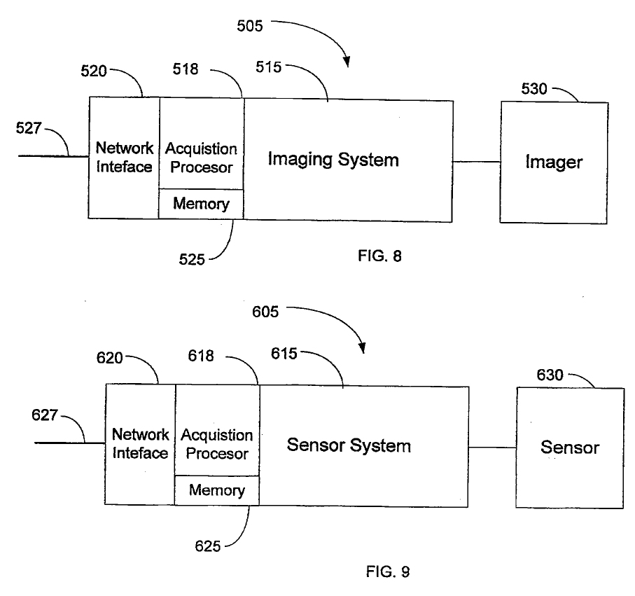

FIG. 9 shows an example of a medical device 605 for a sensor modality. The medical device 605 comprises a network interface 620, an acquisition processor 618, a sensor system 615, and a sensor 630. The sensor 630 may comprise a temperature sensor, a pressure sensor, electrodes for measuring electrical activity in the patient, etc. The sensor system 615 receives signals form the sensor 630. The acquisition processor 618 controls the sensor system 615 based on commands received from the host computer via the network interface 620, and sends measurement data and other information (e.g., status information) to the host computer. The acquisition processor 618 may be PC-based or other type of processor. The acquisition processor 618 communicates with the host computer over the network via the network interface 620, which may comprise a standard network interface card. The device 605 may also include memory 625 for storing software, temporarily storing data being processed, buffering data, and the like. The memory 625 may comprise RAM, nonvolatile memory (e.g., Flash memory), buffers, and/or a combination thereof.

In a preferred embodiment, the network is flexible in that medical devices can be added to and removed from the network, e.g., according to available medical devices. For example, the network eases the installation of new medical devices and the replacement of old devices with new devices. In a preferred embodiment, the medical devices in the network are accessed through a common control console at the host computer. This eliminates the need for each medical device to have its own control console, display and/or image processor, thereby reducing manufacturing and equipment costs. The network also improves workflow for performing different procedures by allowing the physician to access the different modalities though a common interface.

In one embodiment, the host computer comprises a plurality of programs (e.g., software and/or firmware) for interacting with a plurality of different medical devices that may be coupled to the network. In this embodiment, when an medical device is added to the network, the medical device sends an identifier to the host computer identifying the medical device. For example, the identifier may include the manufacturer, model number, and/or device type (e.g., OCT, IVUS, MRI, etc.) of the medical device. When the host computer receives the identifier, the host computer uses the identifier to recognize the medical device and determine which program or software path to use to interact with the medical device. If the host computer does not recognize the medical device, then the host computer may display a message to the operator (e.g., on the monitor) indicating that it does not recognize the medical device. The message may include the manufacturer, model number, and/or device type of the medical device so that the operator can identify the medical device. In this case, the operator may load software for the medical device onto the host computer (e.g., from a removable storage medium) or download the software from a LAN or the Internet.

In another embodiment, the host computer may reserve a predetermined network address and/or a network link for a certain medical device. When the medical device is coupled to the network via the predetermined network address and/or network link, the host computer can automatically recognize and select the medical device without having the medical device send an identifier to the host computer.

In another embodiment, the program (e.g., software) for interacting with the medical device may be stored in memory on the medical device (e.g., in ROM, Flash memory, etc.). In this embodiment, when the medical device is added to the network, the medical device may upload the program to the host computer. This provides the network with plug-and-play capabilities, e.g., for a new medical device that is manufactured after the host computer. In an embodiment, the host computer may already comprise a plurality of program modules (e.g., for performing common functions or routines) that can be used. In this embodiment, the program from the medical device may instruct the host computer which existing program modules on the host computer to use and/or parameters to input into the program modules. This simplifies the amount of program code that needs to be uploaded. This can also ease software development by the medical device vendor by allowing the vendor to utilize program modules already on the host computer.

Further, the host computer may detect the addition and removal of medical devices from the network and update a list of available medical devices accordingly. The host computer may display the list as a plurality of icons on the touch screen, where each icon represents one of the available devices that the operator can select by touching the icon.

Preferably, the program for a medical device is adapted for the host computer to interact with the medical device. For example, the program for a device may include instructions for displaying a set of controls that are adapted to fit within the touch screen coupled to the host computer. The layout of the controls on the touch screen may be specified using an industry standard, e.g., Extensible Markup Language (XML). The layout of the controls may also be specified using a standard (e.g., defined by the host computer manufacturer) that provides a format for specifying the shape and/or size of control buttons on the touch screen, the positions (e.g., coordinates) of the control buttons on the touch screen, the appearance of text boxes, and the like. Such a standard may also include a set of standard controls, templates, control layouts, etc. that can be utilized by the program for the medical device. For example, the standard may include a set of standard controls for a type of imaging modality (e.g., IVUS). The standard advantageously provides a common format and a set of standard controls, templates, etc. that medical device manufacturers or vendors can use to specify the controls and layout of the controls on the touch screen. The standard may be used to provide a degree of uniformity or similar look-and-feel to the controls for the medical device to aid the operator in learning to use the different medical devices.

The controls displayed on the touch screen may also include, e.g., numeric buttons for entering numbers, a knob that can be turned by circular motion of a finger on the touch screen, a pointer on a scale that can be slide to different values along the scale by sliding a finger on the touch screen, and the like. The program for a medical device may select a knob and/or scale from a set of standard knobs and scales, and specify the increments for the knob and/or scale (e.g., how much a parameter value changes for each increment on the scale).

A control button may also include an image representing the function performed by the control. In this example, the program for a medical device may include an image fie of the image, e.g., bitmap or other standard image fie format. The program may also include an icon representing the corresponding medical device. The host computer can display this icon with the icons of other medical devise to allow the operator to select a desired medical device, e.g., by touching the corresponding icon on the touch screen.

The program may also include instructions for specifying how images and/or measurements are displayed on the monitor. For example, the program may include instructions specifying the sizes and/or positions of images and/or measurements and analysis results on the monitor. In another example, the host computer may comprise a plurality of different display formats or templates and the instructions may specify which of the display formats to use.

The program may also include instructions for a set of commands that are associated with the set of controls. The commands may be specified, e.g., by a string of characters that the host computer sends on top of the communications protocols to the medical device when the operator selects the associated control(s). The commands may also include parameters selected by the operator or default parameters. For example, if a command or sequence of commands specifies a pullback imaging procedure, then the parameters may include a pullback length, a pullback rate, and/or a frame rate. In this example, the operator may select the parameters from a set of values displayed on the touch screen and/or enter the parameters using numeric buttons displayed on the touch screen. A command or sequence of commands for a pullback procedure may also have predefined parameters understood by the medical device, in which case the parameters do not need to sent to the medical device.

The program may also include instructions instructing the host computer what data to expect from the medical device in response to a particular command or sequence of commands. For the example of the pullback imaging procedure, the software may include instructions instructing the host computer to receive and record a series of image frames from the corresponding medical device. The instructions may also include a data structure for the image frames instructing the host computer how to process the image frame data from the medical device into images. The host computer may comprise a set of standard data structures for different imaging modalities. In this example, the program may instruct the host computer which of the standard data structures to use to process the image frames. After receiving the image frames, the host computer may use the received image frames and the parameters for the pullback procedure, e.g., to construct and display a three-dimensional image of the blood vessel, display a video of the pullback procedure, playback a selected range of the frames in a continuous loop, and the like.

The program may also specify a workflow for different procedures that the physician may select. For example, the workflow for a particular procedure may comprise a plurality of steps for performing the procedure with rules defining the relationships among the steps. For example, a rule may specify which step comes after the current step based on an input, output and/or state of the current step. As an example, the workflow for an imaging procedure may include a sequence of parameters that have to be entered by the physician. In this example, when the physician enters one of the required parameters, the software may instruct the host computer to display a request for the next parameter to be entered by the physician. Thus, the host computer may walk the physician through the parameters that need to be entered. As another example, the workflow for an imaging procedure may specify what step is performed by the host computer based on data and/or status information received by a medical device. For example, the host computer may receive a preview image from the medical device, after which the host computer may display the preview image to the physician and give the physician the option of continuing the current imaging procedure. The workflow may be modeled using a state model and/or a domain model. The host computer may also comprise a set of standard workflows for different modalities that the program for a medical device can utilize. The standard workflows may be used to provide workflows that conform to good medical practice.

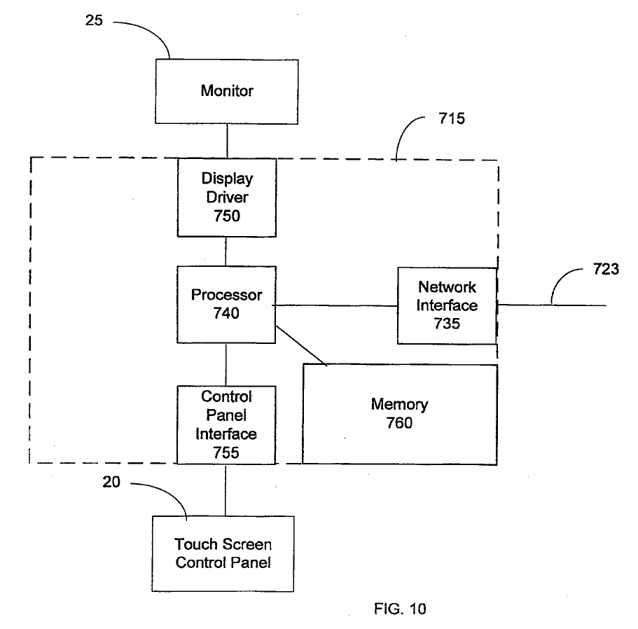

FIG. 10 shows an example block diagram of a host computer 715 according to an embodiment of the present invention. The host computer 715 comprises a network interface 735, a processor 740, a display driver 750, a control panel interface, and memory 760. The processor 740 issues commands to the medical devices (e.g., based operator inputs from the control panel 20), manages workflow, processes data from the medical devices, controls the displays on the monitor 25 and touch screen 20, and the like. The processor 740 may comprise a general purpose processor in combination with a graphics processor, a DSP, and/or other processors. The processor 740 communicates with the medical devices via a network interface 735, which may comprise a standard network interface card (e.g., Ethernet card). The display driver 750 drives the display on the monitor 25 based on display input from the processor 740. The control panel interface 755 drives the display on the touch screen 20 based on input from the processor 740 and sends operator inputs to the processor 740. The memory 760 may comprise RAM memory for temporarily storing data (e.g., image data, measurements, etc.) being worked on, and nonvolatile memory (e.g., hard drive, Flash memory, CD, etc.) for storing software, providing long-term storage of data (e.g., archiving data), etc. For example, the memory 760 may store sets of standard controls, data structures, templates, display layouts, program modules, that can be utilized by the program for a medical device. The host computer 715 may be PC-based. FIG. 10 is intended to provide a high-level description of the host computer 715 and not a detailed architectural description of the host computer, which can vary among PC-based computers.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention can be performed using different or additional process actions, or a different combination or ordering of process actions. As a further example, each feature of one embodiment can be mixed and matched with other features shown in other embodiments. Additionally and obviously, features may be added or subtracted as desired. Accordingly, the invention is not to be restricted except in light of the attached claims and their equivalents.

What is claimed is:

1. A medical network, comprising:
a host computer, wherein the host computer comprises
a storage medium storing a plurality of modules; and
a computer processor; and
a plurality of medical devices communicatively coupled to the host computer, wherein at least one of the medical devices comprises
a storage medium storing a program, wherein the program identifies at least one of the plurality of modules; and
a device processor, wherein the device processor is configured to send the program to the host computer;
wherein the computer processor is configured to use the received program to determine which of the plurality of modules to use for the medical device.

2. The network of claim 1, wherein the medical devices comprise an ultrasound imaging device, an optical imaging device, or an MRI device.

3. The network of claim 1, wherein the plurality of modules comprise a plurality of display layouts.

4. The network of claim 1, wherein the plurality of modules comprise a plurality of data structures.

5. The network of claim 4, wherein the computer processor uses the received program to determine which of the plurality of data structures to use to process data from the corresponding medical device.

6. The network of claim 1, wherein the plurality of modules comprise a plurality of program modules.

7. The network of claim 6, wherein each of the program modules comprises instructions for performing a predefined function.

8. The network of claim 1, further comprising a network hub coupled between the host computer and the medical devices, wherein the network hub comprises at least one coupler that couples communications between the host computer and the medical devices while providing electrical isolation between the host computer and the medical devices.

9. The network of claim 8, wherein the at least one coupler comprises an optical coupler or a transformer.

10. The network of claim 8, wherein the network hub is coupled to at least one of the medical device via a separate link.

11. The network of claim 8, wherein the network hub is coupled to two or more of the medical devices via a shared transmission line.

12. The network of claim 1, wherein the host computer is communicatively coupled to at least one of the medical devices via an Ethernet link.

13. The network of claim 1, further comprising a touch screen control panel coupled to the host computer, wherein the computer processor uses the received program to determine a set of controls to display on the touch screen control panel for the medical device.

14. The network of claim 13, wherein the plurality of modules comprises a plurality of controls, and the computer processor uses the received program to determine which of the plurality of controls to display on the touch screen for the medical device.

15. A medical network, comprising:
a host computer, wherein the host computer comprises
a storage medium storing a plurality of programs; and
a computer processor; and
a plurality of medical devices communicatively coupled to the host computer, wherein at least one of the medical devices comprises
a storage medium storing an identifier that identifies the corresponding medical device; and
a device processor, wherein the device processor is configured to send the identifier to the host computer;
wherein the computer processor is configured to use the received identifier to recognize the corresponding medical device and determine which of the plurality of programs to use for the medical device.

16. The network of claim 15, wherein the medical devices comprise an ultrasound imaging device, an optical imaging device, or an MRI device.

17. The network of claim 15, further comprising a network hub coupled between the host computer and the medical devices, wherein the network hub comprises at least one coupler that couples communications between the host computer and the medical devices while providing electrical isolation between the host computer and the medical devices.

18. A medical network, comprising:
a host computer, wherein the host computer comprises
a storage medium storing a predetermined network address and/or network link associated with a medical device; and
a computer processor, wherein the computer processor is configured to automatically recognize the medical device when the medical device is communicatively coupled to the host computer via the predetermined network address and/or network link.

19. The network of claim 18, wherein the medical device comprises an ultrasound imaging device, an optical imaging device, or an MRI device.

20. The network of claim 18, further comprising a network hub coupled between the host computer and the medical device, wherein the network hub comprises at least one coupler that couples communications between the host computer and the medical device while providing electrical isolation between the host computer and the medical device.
